(19) United States
(12) Patent Application Publication
(10) Pub. No.: US 2011/0070996 A1
(43) Pub. Date: Mar. 24, 2011

(54) CONICAL FRICTION WHEEL TYPE CONTINUOUSLY VARIABLE TRANSMISSION DEVICE

(75) Inventors: Mitsugi YAMASHITA, Anjo (JP); Shoji Takahashi, Anjo (JP); Misaki Kamiya, Anjo (JP); Masayuki Uchida, Anjo (JP)

(73) Assignee: AISIN AW CO., LTD., Anjo-shi (JP)

(21) Appl. No.: 12/850,854

(22) Filed: Aug. 5, 2010

(30) Foreign Application Priority Data
Sep. 18, 2009 (JP) 2009-218122

(51) Int. Cl. F16H 15/42

(52) U.S. Cl. 476/52

(57) ABSTRACT

A conical friction wheel type continuously variable transmission device, wherein speed is steplessly changed by moving a ring in the axial direction. The ring is configured to include a first-side contact surface provided with a linear portion in a cross-section perpendicular to a rotating direction of the ring, and a second-side contact surface provided with a curved portion that is continuous in the cross-section perpendicular to the rotating direction of the ring. A point on the curved portion is positioned offset with respect to a center of the curved portion in a width direction toward a larger diameter portion side of the friction wheel on which the second-side contact surface contacts, and a distance from the point to an edge portion on the small diameter portion side of the curved portion is set longer than a distance from the point to an edge portion on the large diameter portion side.

### INCORPORATION BY REFERENCE

The disclosure of Japanese Patent Application No. 2009-218122 filed on Sep. 18, 2009 including the specification, drawings and abstract is incorporated herein by reference in its entirety.

### BACKGROUND OF THE INVENTION

The present invention relates to a conical friction wheel type continuously variable transmission device that includes: a pair of conical friction wheels disposed parallel to each other and disposed such that large diameter portions and small diameter portions of the friction wheels are respectively disposed opposite to each other in an axial direction; and a ring interposed between opposing inclined surfaces of the friction wheels, wherein speed is steplessly changed by moving the ring in the axial direction. Specifically, the present invention relates to the configuration of the ring.

### DESCRIPTION OF THE RELATED ART

As shown in FIG. 4A, in the related art, a conical friction wheel type continuously variable transmission device (cone ring type continuously variable transmission device) 101 is known that includes an input-side conical friction wheel 22, an output-side conical friction wheel 23, and a metal ring 125 interposed between opposing inclined surfaces of the friction wheels, so as to surround the input-side friction wheel 22. In the cone ring type continuously variable transmission device 101, respective axes of the friction wheels are parallel to each other, and large diameter portions and small diameter portions of the friction wheels are respectively disposed opposite to each other in an axial direction. With this configuration, the cone ring type continuously variable transmission 101 steplessly changes speed by moving the ring 125 in the axial direction.

In the cone ring type continuously variable transmission 101, a large axial force corresponding to transferred torque and the like are applied in an oil environment, such as with traction oil, and a large contact pressure is applied in the state where an oil film exists between the ring 125 and the friction wheels 22, 23 at contact portions thereof, whereby power is transmitted.

As shown in FIG. 4B, in the related art, an inner contact surface 126 of the ring 125 contacts the input-side friction wheel 22 and includes a linear portion 126a positioned in a center region, and curved portions 126b, 126e that are provided on both sides of the center region and have relatively large curvatures. An outer contact surface 127 of the ring 125 also contacts the output-side friction wheel 23 and includes a curved portion 127a having a relatively large radius R (center O) (refer to Published Japanese Translation of PCT Application No. JP-A-2009-506279, paragraphs [0181] to [0184], FIG. 7). With this configuration, vibration of the ring is suppressed through linear contact between the input-side friction wheel 22 and the linear portion 126a on the inner contact surface 126 of the ring 125, and the speed can be smoothly changed as the outer contact surface 127 contacts the output-side friction wheel 23 at a point (contact point P) on the curved portion 127a.

### SUMMARY OF THE INVENTION

### Problems to be Solved by the Invention

The ring 125 is set so that a centerline of curvature (radius) R of the outer surface curved portion 127a passing through a width-direction center point Q of the inner surface linear portion 126a is positioned at the width-direction center of the curved portion 127a. That is, the width-direction center portion P of the ring outer contact surface 127 is positioned at a point farthest from the inner surface linear portion 126a, and a peak point is set to the contact point P at which the outer contact surface 127 contacts the output-side friction wheel 23. With this configuration, when the inner surface contact portion center Q and the outer surface contact portion P are positioned at the width-direction center of the ring 125, a large clamping force F is applied from the friction wheels 22, 23 to the ring 125 in the direction of the same line (R). Consequently, a moment occurring on the ring 125 can be suppressed and power transmission loss can be reduced, which is preferable in terms of transmission efficiency.

However, in the cone ring type continuously variable transmission device 101, a large contact pressure is applied to the contact portions between the ring 125 and the friction wheels 22, 23, and power is transmitted through a shear force of the oil film in an extreme pressure condition. Therefore, a large load is applied to the friction wheels 22, 23 in a direction separating the friction wheels 22, 23 from each other. When the continuously variable transmission device 101 is used for driving a vehicle and a large load is applied, and particularly when the cone ring type continuously variable transmission device 101 is used in a low speed condition (underdrive condition), deformation of the input-side friction wheel, especially, deformation of the small diameter portion thereof, is large because of the large transferred torque and low rigidity in the small diameter portion of the input-side friction wheel 22 (see an axis line l to an axis line l′ shown in FIG. 4A).

Thus, as shown in FIG. 4C, the input-side friction wheel 22 deforms in a direction that separates the small diameter portion side of the input-side friction wheel 22 from the output-side friction wheel 23, that is, in a direction that increases an angle of inclination α formed by a contact inclination surface 22e of the input-side friction wheel 22. The ring 125 also inclines in accordance with the deformation described above when the inner surface linear portion 126a contacts the input-side friction wheel 22, and an outer surface contact point P₁ formed on the curved portion 127a is moved to the small diameter portion side of the output-side friction wheel 23. This moves the outer surface contact point P₁ of the ring 125 closer to a corner portion, and a local surface pressure is generated at the corner portion, resulting in a reduction of durability of the ring 125, and by extension, the cone ring type continuously variable transmission device 101, thus reducing transmission efficiency.

In consideration of the foregoing, it is an object of the present invention to provide a conical friction wheel type continuously variable transmission device that solves the above problems by setting a movable range of an outer surface contact point of a ring longer in a moving direction when the friction wheel deforms as described above.

According to a first aspect of the present invention, a curved portion of a second-side contact surface is disposed such that a point (referred to as a contact point) on the curved portion, which is farthest from a linear portion, is positioned offset to a large diameter portion side of another friction wheel that the curved portion contacts. Therefore, even when one friction wheel, especially, a small diameter portion side of the one friction wheel, deforms due to a contact pressure, and a contact point is moved to the small diameter portion side, a local surface pressure is prevented from occurring on an edge (corner) portion due to the long distance to the edge portion on the small diameter portion side. This improves the durability of a ring, and by extension, the durability of the continuously variable transmission device, and also improves transmission efficiency without applying an unusual force to the ring.

According to a second aspect of the present invention, an inner contact surface of the ring is the linear portion, and an outer contact surface is the curved portion. Accordingly, even when the one friction wheel deforms on the small diameter portion side, and the contact point is moved to the small diameter portion side, the distance to the edge portion on the small diameter portion side is long, and thus a local surface pressure is prevented from occurring on the edge (corner) portion. Consequently, the durability of the ring can be improved.

According to a third aspect of the present invention, because the curved portion is formed of an arc about a single point, the second-side contact surface of the ring is smoothly moved even with the deformation of the friction wheel. Further, the first-side contact surface is formed of the linear portion to suppress rotation vibration of the ring. Good transmission efficiency can be thus maintained through the combination of these features.

According to a fourth aspect of the present invention, a force applied to the first-side contact surface of the ring and a force applied to the second-side contact surface of the ring are on the same line, and thus a moment is suppressed from acting on the ring so as to prevent reduced durability due to movement of the contact point on the second-side contact surface. Moreover, it is also possible to prevent a reduction in the transmission efficiency by stabilizing the rotation of the ring.

According to a fifth aspect of the present invention, a plane of rotation of the ring is set at an angle that is raised toward a direction perpendicular to axes, and thus an unusual force is not generated when the ring rotates, thereby improving the transmission efficiency.

According to a sixth aspect of the present invention, a side surface of the ring is formed of a plane perpendicular to the axes. Therefore, even if the contact point is positioned offset, the entire ring forms a natural parallelogram, and the plane of rotation of the ring is perpendicular to the axes. This achieves compact configuration with a short diameter.

According to a seventh aspect of the present invention, because the second-side contact surface is entirely formed of the curved portion, the contact point is movable in a maximum range when the friction wheel deforms, and this allows improvement of the durability of the ring.

According to an eighth aspect of the present invention, because the one friction wheel surrounded by the ring is an input member, the durability of the ring can be improved when the friction wheel deforms in a decelerating (underdrive) state where a transferred torque is large.

According to a ninth aspect of the present invention, when the second-side axial portions of the friction wheels are supported by a case such as a partition, the one friction wheel must be supported by a bearing to provide play when assembled. Even if the one friction wheel deforms in the state of shaft support with play, such deformation can be absorbed by expanding a movable range of the contact point using the configuration of the ring described above.

### BRIEF DESCRIPTION OF THE DRAWINGS

FIG. 1 is a front cross-sectional view showing a hybrid drive system to which the present invention is applied;

FIG. 2 is a front cross-sectional view showing a conical friction wheel (cone ring) type continuously variable transmission device in the hybrid vehicle;

FIGS. 3A and 3B show lateral cross-sectional views of a ring of the conical friction wheel type continuously variable transmission device according to the present invention, in which FIG. 3A shows a state where no load is applied (i.e., a friction wheel does not deform), and FIG. 3B shows a state where a load is applied (i.e., the friction wheel deforms); and

FIGS. 4A to 4C show related art, in which FIG. 4A is a cross-sectional view showing an outline of a conical friction wheel type continuously variable transmission device, FIG. 4B is a lateral cross-sectional view showing a ring when no load is applied, and FIG. 4C is a lateral cross-sectional view showing the ring when a load is applied.

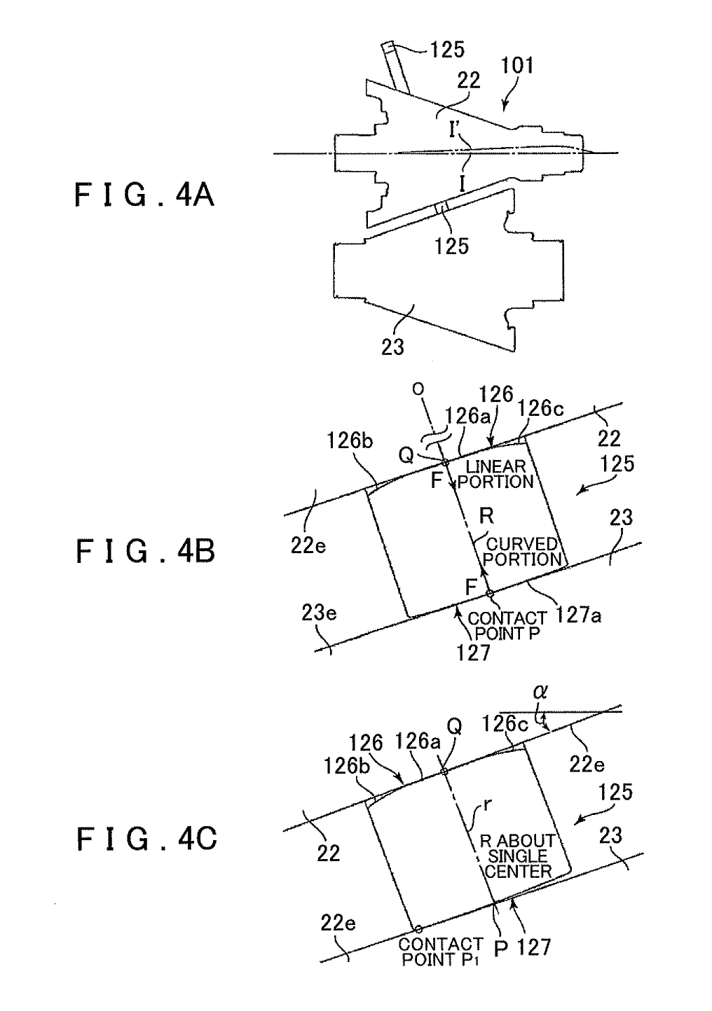

### DETAILED DESCRIPTION OF THE EMBODIMENTS

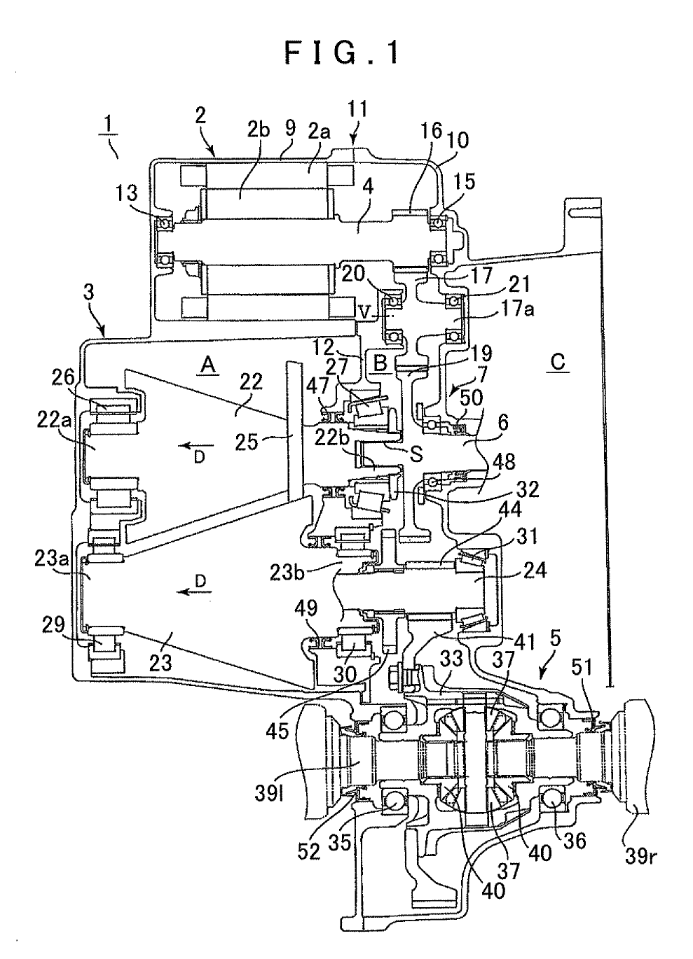

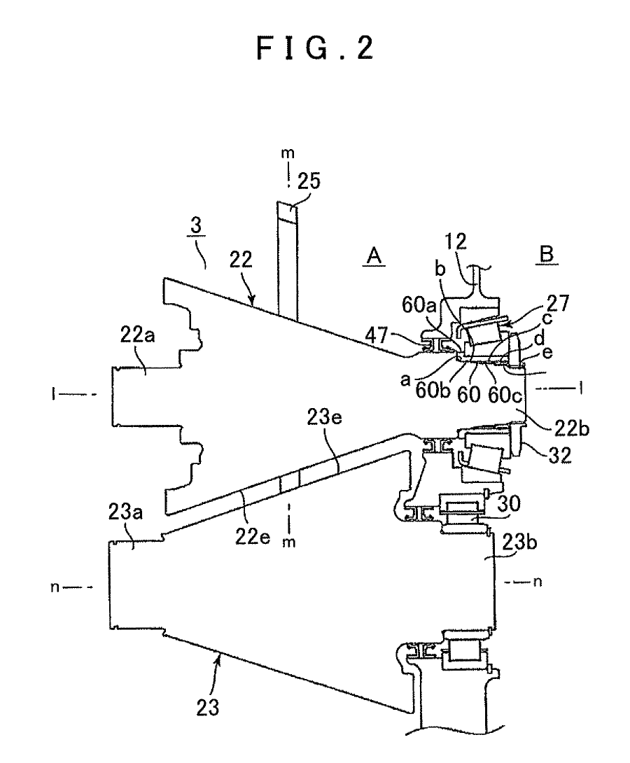

A hybrid drive system to which the present invention is applied will be described below with reference to the attached drawings. As shown in FIGS. 1 and 2, a hybrid drive system 1 includes an electric motor 2, a cone ring type continuously variable transmission device (conical friction wheel type continuously variable transmission device) 3, a differential device 5, an input shaft 6 that moves in accordance with an output shaft of an engine (not shown), and a gear transmission device 7. The above devices and shafts are housed in a case 11 that is formed by two case members, that is, a case member 9 and a case member 10. Further, the case 11 includes a first space A and a second space B divided by a partition 12 in an oil-tight manner.

The electric motor 2 includes a stator 2a fixed to the first case member 9, and a rotor 2b provided on an output shaft 4. A first end portion of the output shaft 4 is rotatably supported by the first case member 9 through a bearing 13, and a second end portion of the output shaft 4 is rotatably supported by the second case member 10 through a bearing 15. An output gear 16 consisting of a toothed gear (pinion) is formed on a first side of the output shaft 4, and meshes with an intermediate gear (toothed gear) 19 provided on the input shaft 6 through a toothed idler gear 17.

A shaft 17a of the toothed idler gear 17 includes a first end portion that is rotatably supported by the partition 12 through a bearing 20, and a second end portion that is rotatably supported by the second case member 10 through a bearing 21. The toothed idler gear 17 is disposed partially overlapping with the electric motor 2 in a radial direction when viewed from the side (that is, when viewed in an axial direction).

The cone ring type continuously variable transmission device 3 includes a conical friction wheel 22 serving as an input member, a conical friction wheel 23 serving as an output member, and a ring 25 made of metal. The friction wheels 22, 23 are disposed so that respective axes of the friction wheels 22, 23 are parallel to each other, and a small diameter portion and a large diameter portion of the friction wheel 22 are disposed axially opposite to a small diameter portion and a large diameter portion of the friction wheel 23. The ring 25 is interposed between opposing inclined surfaces of the friction wheels 22, 23, and surrounds one of the friction wheels, for example, the input-side friction wheel 22. A large thrust force is applied to at least one of the friction wheels, and therefore the ring 25 is interposed between the inclined surfaces by a relatively large clamping force based on the above thrust force. Specifically, an axial force application unit (not shown) formed of a cam mechanism is formed between the output-side friction wheel 23 and an output shaft 24 of the continuously variable transmission device, on opposing surfaces in the axial direction. The thrust force in a direction shown by an arrow D in the drawing is generated in accordance with the transferred torque, and a large clamping force is generated to act on the ring 25 between the output-side friction wheel 23 and the input-side friction wheel 22 that is supported in a direction that counters the thrust force.

The input-side friction wheel 22 includes a first end portion (large diameter portion) supported by the first case member 9 through a roller bearing 26, and a second end portion (small diameter portion) supported by the partition 12 through a tapered roller bearing 27. The output-side friction wheel 23 includes a first end portion (small diameter portion) supported by the first case member 9 through a roller (radial) bearing 29, and a second end portion (large diameter portion) supported by the partition 12 through a roller (radial) bearing 30. The output shaft 24, which applies to the output-side friction wheel 23 the thrust force acting in the direction shown by the arrow D as described above, includes a second end portion supported by the second case member 10 through a tapered roller bearing 31. An inner race of the bearing 27 is interposed between a step portion and a nut 32 on the second end portion of the input-side friction wheel 22, and the thrust force that acts on the input-side friction wheel 22 through the ring 25 in the direction shown by the arrow D from the output-side friction wheel 23 is supported by the tapered roller bearing 27. On the other hand, a reaction force of the thrust force acting the output-side friction wheel 23 acts on the output shaft 24 in a direction opposite to the direction shown by the arrow D, and the reaction force of the thrust force is supported by the tapered roller bearing 31.

The ring 25 moves in the axial direction by an axial moving unit, such as a ball screw, and changes the positions of contact between the ring 25 and the input-side friction wheel 22 and between the ring 25 and the output-side friction wheel 23, so as to steplessly change speed by steplessly changing a rotation ratio between the input member 22 and the output member 23. The thrust force D in accordance with the transferred torque and the reaction force of the thrust force are canceled out by the tapered roller bearings 27, 31 in the integrated case 11, and an equilibrant force as an external force such as a hydraulic pressure is not required.

The differential device 5 includes a differential case 33, and the differential case 33 includes a first end portion supported by the first case member 9 through a bearing 35, and a second end portion supported by the second case member 10 through a bearing 36. A shaft that is perpendicular to the axial direction is attached to the inside of the differential case 33, and bevel gears 37, 37, which serve as differential carriers, are engaged with the shaft. Left and right axle shafts 39l, 39r are supported by the shaft, and bevel gears 40, 40 that mesh with the differential carriers are fixed to the axle shafts. Further, a differential ring gear (toothed gear) 41 having a large diameter is attached to the outside of the differential case 33.

The output shaft 24 of the continuously variable transmission device is formed with a gear (pinion) 44, and the gear 44 meshes with the differential ring gear 41. The motor output gear (pinion) 16, the toothed idler gear 17, the intermediate gear 19, the output gear (pinion) 44 of the continuously variable transmission device, and the differential ring gear 41 constitute the gear transmission device 5. The motor output gear 16 and the differential ring gear 41 are disposed overlapping each other in the axial direction, and the intermediate gear 19 and the output gear 44 of the continuously variable transmission device are disposed overlapping the motor output gear 16 and the differential ring gear in the axial direction. Note that, a gear 45, which is engaged with the output shaft 24 of the continuously variable transmission device through a spline, is a parking gear that locks the output shaft when a shift lever is in a parking position. Further, the term “gear” refers to a meshing rotary transmission unit including toothed gears and sprockets. In this embodiment, however, the gear transmission device refers to a toothed gear transmission device that is formed by toothed gears only.

The input shaft 6 is supported by the second case member 10 through a roller bearing 48. The input shaft 6 is engaged (drivingly connected) with the input member 22 of the continuously variable transmission device 3 at a first end thereof through a spline S, and a second end of the input shaft 6 is linked with the output shaft of the engine through a clutch (not shown) housed in a third space C defined by the second case member 10, so that the input shaft 6 moves in accordance with the output shaft of the engine. The second case member 10 is open and connected to the engine (not shown) on a third space C side.

The gear transmission device 7 is housed in the second space B. The second space B is a space between the third space C, and the electric motor 2 and the first space A, in the axial direction. The second space B is defined by the second case member 10 and the partition 12. The shaft-supporting portions (27, 30) of the partition 12 are placed in an oil-tight state by oil seals 47, 49, respectively, and the shaft-supporting portions of the second case member 10 and the first case member 9 are shaft-sealed by oil seals 50, 51, 52. The second space B is configured to be oil-tight, and is filled with a predetermined amount of lubricant oil such as ATF. The first space A defined by the first case member 9 and the partition 12 is similarly configured to be oil-tight, and is filled with a predetermined amount of traction oil having a shear force, and a large shear force under an extreme pressure condition in particular.

Next, the operation of the hybrid drive system 1 as described above will be explained. The hybrid drive system 1 is connected to an internal combustion engine on the third space C side of the case 11, and the output shaft of the engine is connected to the input shaft 6 through a clutch. The power from the engine is transmitted to the input shaft 6, and the rotation of the input shaft 6 is transmitted to the input-side friction wheel 22 in the cone ring type continuously variable transmission device 3 through the spline S. The power is further transmitted to the output-side friction wheel 23 through the ring 25.

During this transmission, a large contact pressure acts between the friction wheels 22, 23 and the ring 25 due to the thrust force acting on the output-side friction wheel 23 in the direction shown by the arrow D. Because the first space A is filled with the traction oil, an oil film of the traction oil is formed between the friction wheels and the ring, bringing about the extreme pressure condition. In this condition, the traction oil has a large shear force, and thus the power is transmitted between the friction wheels and the ring by the shear force of the oil film. This allows the transfer of a predetermined torque in a non-slip manner without causing wear on the friction wheels and the ring, even though the torque transfer is made through contact between metal members. Moreover, the ring 25 slips in the axial direction smoothly to change the positions of contact between the friction wheels and the ring, whereby the speed is steplessly changed.

The rotation of the output-side friction wheel 23 whose speed has been steplessly changed is transmitted to the differential case 33 of the differential device 5 through the output shaft 24, the output gear 44, and the differential ring gear 41. The power is then distributed to the left and right axle shafts 39l, 39r so as to drive the vehicle wheels (front wheels).

On the other hand, the power from the electric motor 2 is transmitted to the input shaft 6 through the output gear 16, the toothed idler gear 17, and the intermediate gear 19. Similar to the description above, the speed of the rotation of the input shaft 6 is steplessly changed by the cone ring type continuously variable transmission device 3, and the rotation is transmitted to the differential device 5 through the output gear 44 and the differential ring gear 41. The gear transmission device 7 formed by the gears 16, 17, 19, 44, 41, 37, 40 is housed in the second space B filled with the lubricant oil, and therefore the power is smoothly transmitted through the lubricant oil when the gears mesh. At such time, because the differential ring gear 41 (see FIG. 2) disposed at a lower position in the second space B is formed of a large diameter gear, the differential ring gear 41 scoops up the lubricant oil so that a sufficient amount of lubricant oil is reliably supplied to the other gears 16, 17, 19, 44 and the bearings 27, 30, 20, 21, 31, 48.

Various operation modes of the engine and the electric motor, that is, operation modes as the hybrid drive system 1, may be employed as necessary. As an example, when the vehicle starts off, the clutch is disconnected and the engine is stopped so that the vehicle is started using only the torque from the electric motor 2. Once the vehicle speed reaches a predetermined speed, the engine is started and the vehicle is accelerated by the power from the engine and the electric motor. When the vehicle speed becomes a cruising speed, the electric motor goes into a free rotation or is placed in a regeneration mode, and the vehicle travels using only the power from the engine. During deceleration or braking, the electric motor regenerates to charge a battery. Further, the vehicle may be started by the power from the engine using the clutch as a starting clutch, with the torque from the motor used as an assisting power.

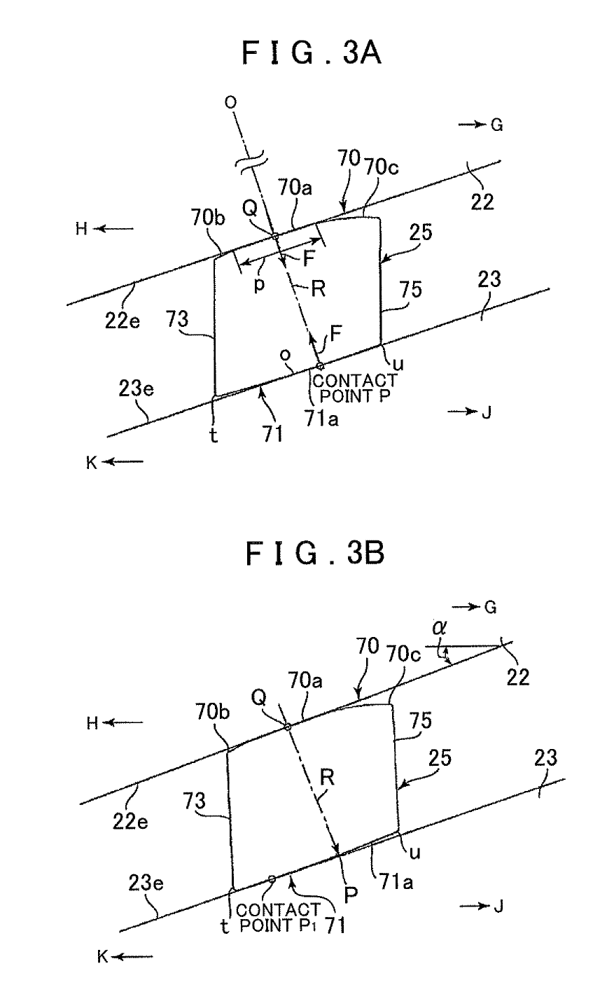

Next, with reference to FIGS. 2 and 3, the conical friction wheel (cone ring) type continuously variable transmission device 3 according to the present invention will be described. The continuously variable transmission device 3 includes the input-side friction wheel 22, the output-side friction wheel 23, and the ring 25 as described above, and the friction wheels 22, 23 and the ring 25 are made of metal such as steel. The friction wheels 22, 23 are disposed so that axes l-l, n-n of the friction wheels 22, 23 are parallel to each other, and formed in a conical shape so that inclined surfaces are linearly formed. The ring 25 is interposed between opposing inclined surfaces 22e, 23e. The ring 25 is disposed so as to surround one of the friction wheels, specifically, the input-side friction wheel 22, and a cross-section taken along a plane perpendicular to a circumferential direction of the ring 25 is substantially a parallelogram shape. A plane of rotation m-m of the ring 25 is set substantially perpendicular to the axis l-l.

The cone ring type continuously variable transmission device 3 is assembled by inserting the partition 12 into second-side axial portions 22b, 23b of the friction wheels 22, 23, in the state where first-side axial portions 22a, 23a are supported by the first case member 9 through bearings 26, 29, respectively. During this assembling, it is difficult in terms of axial accuracy to press-fit the inner races of the bearings 27, 30, and thus the inner race of one of the bearings 27, 30 is fit to the corresponding axial portion with play therebetween. Specifically, the axial portion 22b of the input-side friction wheel 22 is fit to the bearing 27 with play therebetween and supported by the bearing 27. An outer race of the roller bearing 30 is press-fit to and retained by the partition, and the inner race is press-fit to and retained on the axial portion, between the second-side axial portion 23b of the output-side friction wheel 23 and the partition 12 to attach the roller bearing 30.

The tapered roller bearing 27 that supports the second-side axial portion 22b of the input-side friction wheel 22 is attached to the partition 12 by press-fitting the outer race of the tapered roller bearing 27 to the partition 12, as well as the roller and the inner race thereof. A sleeve 60 is press-fit to an inner diameter side of an inner race 27a, and integrally fixed to the inner race 27a. The sleeve 60 forms a flange portion 60a of which one end side (a conical side) extends in an outer diameter direction. A large diameter dowel portion 60b, a spline portion 60e, and a small diameter dowel portion 60d are sequentially formed on an inner diameter side of the flange portion 60a from the conical side to a tip end side of the sleeve 60.

On the other hand, the second-side axial portion 22b of the input-side friction wheel 22 is sequentially formed with a stepped portion a, a large diameter support portion b, a spline portion c, a small diameter support portion d, and an external thread portion e from a conical side of the second-side axial portion 22b to a tip end thereof. The partition 12 is assembled so that the second-side axial portion 22b is inserted into the sleeve 60 that is integrally press-fit to the bearing 27. During such assembling, the large diameter dowel portion 60b of the sleeve 60 and the large diameter support portion b of the axial portion 22b are fit to each other with play therebetween, and the small diameter dowel portion 60d and the small diameter support portion d are fit to each other with play therebetween. Further, the spline portions 60c, c are engaged with each other. With this configuration, the second-side axial portion 23b of the output-side friction wheel 23 is supported by the roller bearing 30 in a state where the inner race of the roller bearing 30 is press-fit to the second-side axial portion 23b, and the partition 12 can be inserted with the second-side axial portion 22b of the input-side friction wheel 22 because there is play between the sleeve 60 and the second-side axial portion 22b. Further, the external thread portion e is screwed into the nut 32 so as to abut the flange portion 60a of the sleeve 60 against the stepped portion a. The nut 32 is pressed against an outer side face of the inner race 27a, so that the axial portion 22b is tightened to restrict its movement in the axial direction with respect to the bearing 27.

FIGS. 3A and 3B show cross-sectional views taken along a plane (a plane including the axes l-l, n-n of the friction wheels) perpendicular to the rotating direction of the ring. FIG. 3A shows a natural state where the friction wheel does not deform with no load or a light load applied to the continuously variable transmission device 3. FIG. 3B shows a state where the friction wheel deforms with a load applied to the continuously variable transmission device. In this state, as described above, the input-side friction wheel 22 is supported by the partition 12 having play with the axial portion 22b on the small diameter portion G side thereof. The small diameter portion G has a small diameter and thus low rigidity, and the rotation speed of the input-side friction wheel 22 is faster at cruising speeds that are often used for long periods of time. Thus, the deformation of the input-side friction wheel 22 on the small diameter portion G side has a significant effect on the ring 25.

As shown in FIG. 3A, the ring 25 according to the present invention includes: an inner (first-side) contact surface 70 that contacts the inclined surface 22e of the input-side friction wheel 22; an outer (second-side) contact surface 71 that contacts the inclined surface 23e of the output-side friction wheel 23; and left and right side surfaces 73, 75, each of which is formed of a plane perpendicular to the rotating direction of the ring, that is, the axis l-l of the friction wheel. The inner contact surface 70 includes a linear portion 70a of a predetermined length p when viewed in a cross-section taken perpendicular to the rotating direction of the ring. Curved surface portions 70b, 70c, which have relatively large curvatures, are formed on the left and right sides of the linear portion, respectively. The outer contact surface 71 is formed of a curved portion 71a that is continuous in a cross-section taken perpendicular to the rotating direction of the ring, and is preferably formed of an arc having a relatively large radius R about a single center point O.

The linear portion 70a of the inner contact surface 70 is positioned closer (offset) to a large diameter portion H side of the input-side friction wheel 22 which the linear portion 70a contacts, and the curved portion 70c on the small diameter portion G side is set longer than the curved portion 70b on the large diameter portion side. A point P on the outer surface curved portion 71a passing through the center point Q of the linear portion 70a is a point farthest from the linear portion 70a. That is, the inner contact surface 70 contacts the input-side friction wheel 22 at the linear portion 70a, and the outer contact surface 71 contacts the output-side friction wheel 23 at the point P farthest from the linear portion 70a (more precisely, from the center point Q of the linear portion 70a), whereby the point serves as the contact point P. The contact point P is positioned offset with respect to a center o in a width direction of the curved portion 71a toward a side that is opposite to the side toward which the center point Q is offset.

In other words, the center O of the radius R of the curved portion 71a formed of the above arc is positioned on the large diameter portion H side of the input-side friction wheel 22, and the radius R passing through the center point Q of the linear portion 70a serves as a perpendicular bisector of the linear portion 70a. The contact point P, which is an intersection point on the curved portion 71a with the radius R passing the center point Q, is positioned offset to a small diameter portion J side of the output-side friction wheel 23 which the curved portion (the outer contact surface 71) contacts, with respect to the center point o in the width direction of the curved portion. Therefore, the distance from the contact point P to an edge portion t on a small diameter portion K side of the curved portion 71a is set longer than the distance from the contact point P to an edge portion u on the large diameter portion J side. Note that, the curved portion 71a is entirely formed across the outer contact surface 71 in the width direction, and this configuration is preferable because the movable range of the contact point P due to deformation of the friction wheel, which will be described later, is expanded. However, the present invention is not limited to the configuration in which the curved portion 71a extends entirely across in the width direction, and a portion close to the side surface may be formed as another curved surface or an inclined surface.

The plane of rotation m-m of the ring 25 (see FIG. 2) is set at an angle that is raised toward the direction perpendicular to the axes of the friction wheels with respect to the angles perpendicular to the incline surfaces 22e, 23e of the friction wheels 22, 23 on which the ring 25 contacts. Preferably, the plane of rotation m-m of the ring is formed of a plane perpendicular to the axes l-l, n-n, and the side surfaces 73, 75 are formed of planes perpendicular to the axes.

The cone ring type continuously variable transmission device 3 transmits power such that the friction wheels 22, 23 hold the ring 25 therebetween at a contact pressure in accordance with the transferred torque. In the decelerating (underdrive) state where no load or a light load is applied, or where the ring is positioned on the large diameter portion H side of the input-side friction wheel 22, the deformation of the friction wheel is small and the state of the ring 25 is as shown in FIG. 3A. In this state, the linear portion 70a of the inner contact surface 70 of the ring 25 contacts the input-side friction wheel 22, and the outer contact surface 71 contacts the output-side friction wheel 23 near the contact point P on the curved portion 71a. In the state where vibration of the ring is suppressed with the force F applied to the linear portion 70a (center point Q) from the input-side friction wheel 22 and the force F applied to the contact point P of the curved portion 71a from the output-side friction wheel 23 acting on the same line (R), the ring 25 rotates smoothly on the plane of rotation m-m without application of a moment, and transmits the power with high transmission efficiency.

In the state where a large load is applied to the cone ring type continuously variable transmission device 3, and particularly, in the decelerating (underdrive) state where the ring 25 is positioned on the small diameter portion G side on which the input-side friction wheel 22 is likely to be deformed, the state of the ring 25 is as shown in FIG. 3B. That is, the input-side friction wheel 22 deforms in a direction that increases the angle of inclination α on the contact-side inclined surface 22e of the input-side friction wheel 22, and the ring 25 linearly contacting the linear portion 70a is also inclined in accordance with the deformation. Consequently, the contact point P on the curved portion 71a of the outer contact surface 71 at which the ring 25 contacts the output-side friction wheel 23 is moved to the small diameter portion K side of the friction wheel 23 (P→P₁).

The contact point P on the curved portion 71a in the no-load state is positioned offset to the large diameter portion J side in advance. Therefore, even if the contact point P₁ is moved in accordance with the deformation of the friction wheel as described above, the contact point P₁ is kept from moving up to the edge (corner) portion t of the curved portion because the length on the small diameter K side is set longer. Thus, the contact point P₁ settles at the middle position of the curved portion 71a. This prevents a local surface pressure from acting on the corner portion t of the outer contact surface 71, whereby fatigue fracturing of the ring 25 is reduced. The durability of the ring 25, and by extension, the durability of the cone ring type continuously variable transmission device 3 is thus improved, making it possible to maintain the power transmission with high transmission efficiency for a long time.

The above description concerns an embodiment in which the continuously variable transmission device is applied to a hybrid drive system. However, the present invention is not limited to this, and may be applied to a drive device other than the hybrid drive system as another type of gear transmission device, such as a gear transmission device that serves as a reverse gear transmission device, or uses a planetary gear that separates and transfers a part of torque and combines the torque with an output from the continuously variable transmission device, so as to expand the shift range of the continuously variable transmission device or distribute a part of the transferred torque. Further, the present invention may be singly used as a continuously variable transmission device. In this case, it is preferable that the present invention be applied to a transport machine, such as an automobile. However, the present invention may be applied to other power transmission apparatuses, such as an industrial machine.

The present invention relates to a conical friction wheel type continuously variable transmission device (cone ring type CVT), and can be used in any and all power transmission apparatuses, including a transport machine such as a hybrid drive system, and an industrial machine.

What is claimed is:

1. A conical friction wheel type continuously variable transmission device comprising:
a pair of conical friction wheels disposed on mutually parallel axes and disposed such that large diameter portions and small diameter portions of the friction wheels are respectively disposed opposite to each other in an axial direction, and
a ring disposed so as to surround one of the friction wheels and interposed between opposing inclined surfaces of the friction wheels, wherein speed is steplessly changed by moving the ring in the axial direction, wherein
the ring includes a first-side contact surface provided with a linear portion in a cross-section perpendicular to a rotating direction of the ring, and a second-side contact surface provided with a curved portion that is continuous in the cross-section perpendicular to the rotating direction of the ring, and
a point on the curved portion that is farthest from the linear portion is positioned offset with respect to a center of the curved portion in a width direction toward a larger diameter portion side of the friction wheel on which the second-side contact surface contacts, and a distance from the point to an edge portion on the small diameter portion side of the curved portion is set longer than a distance from the point to an edge portion on the large diameter portion side.

2. The conical friction wheel type continuously variable transmission device according to claim 1, wherein
the first-side contact surface is an inner contact surface on an inner side of the ring, and
the second-side contact surface is an outer contact surface on an outer side of the ring.

3. The conical friction wheel type continuously variable transmission device according to claim 1, wherein
the curved portion is formed of an arc about a single point.

4. The conical friction wheel type continuously variable transmission device according to claim 1, wherein
the point on the curved portion is set on a perpendicular bisector of the linear portion.

5. The conical friction wheel type continuously variable transmission device according to claim 1, wherein
a plane of rotation of the ring is set at an angle that is raised toward a direction perpendicular to the axis of the friction wheel with respect to an angle perpendicular to the inclined surfaces of the friction wheels that the ring contacts.

6. The conical friction wheel type continuously variable transmission device according to claim 5, wherein
an edge side surface of the ring in the width direction is formed of a plane perpendicular to the axes of the friction wheels, and
the plane of rotation of the ring is set at an angle perpendicular to the axes.

7. The conical friction wheel type continuously variable transmission device according to claim 1, wherein
the second-side contact surface is entirely formed of the curved surface.

8. The conical friction wheel type continuously variable transmission device according to claim 1, wherein
the one friction wheel surrounded by the ring is an input member, and the other of the pair of friction wheels is an output member.

9. The conical friction wheel type continuously variable transmission device according to claim 1, wherein
an axial portion on a small diameter portion side of the one friction wheel is supported by an inner race of a bearing, which is attached to a case, with play therebetween through a rotation stopper.

10. The conical friction wheel type continuously variable transmission device according to claim 2, wherein
the curved portion is formed of an arc about a single point.

11. The conical friction wheel type continuously variable transmission device according to claim 10, wherein
the point on the curved portion is set on a perpendicular bisector of the linear portion.

12. The conical friction wheel type continuously variable transmission device according to claim 11, wherein
a plane of rotation of the ring is set at an angle that is raised toward a direction perpendicular to the axis of the friction wheel with respect to an angle perpendicular to the inclined surfaces of the friction wheels that the ring contacts.

13. The conical friction wheel type continuously variable transmission device according to claim 12, wherein
an edge side surface of the ring in the width direction is formed of a plane perpendicular to the axes of the friction wheels, and
the plane of rotation of the ring is set at an angle perpendicular to the axes.

14. The conical friction wheel type continuously variable transmission device according to claim 13, wherein
the second-side contact surface is entirely formed of the curved surface.

15. The conical friction wheel type continuously variable transmission device according to claim 14, wherein
the one friction wheel surrounded by the ring is an input member, and the other of the pair of friction wheels is an output member.

16. The conical friction wheel type continuously variable transmission device according to claim 15, wherein
an axial portion on a small diameter portion side of the one friction wheel is supported by an inner race of a bearing, which is attached to a case, with play therebetween through a rotation stopper.

17. The conical friction wheel type continuously variable transmission device according to claim 2, wherein
the point on the curved portion is set on a perpendicular bisector of the linear portion.

18. The conical friction wheel type continuously variable transmission device according to claim 2, wherein
a plane of rotation of the ring is set at an angle that is raised toward a direction perpendicular to the axis of the friction wheel with respect to an angle perpendicular to the inclined surfaces of the friction wheels that the ring contacts.

19. The conical friction wheel type continuously variable transmission device according to claim 3, wherein
the point on the curved portion is set on a perpendicular bisector of the linear portion.

20. The conical friction wheel type continuously variable transmission device according to claim 3, wherein
a plane of rotation of the ring is set at an angle that is raised toward a direction perpendicular to the axis of the friction wheel with respect to an angle perpendicular to the inclined surfaces of the friction wheels that the ring contacts.
